(19) United States
(12) Patent Application Publication
(10) Pub. No.: US 2010/0255231 A1
(43) Pub. Date: Oct. 7, 2010

(54) OXYGEN SCAVENGING FILMS

(75) Inventors: Chieh-Chun Chau, Victor, NY (US); Thomas H. Powers, Mayville, NY (US); Stanislav E. Solovyov, Getzville, NY (US)

Correspondence Address: Stephen B. Salai, Esq.;Harter Secrest & Emery LLP, 1600 Bausch & Lomb Place, Rochester, NY, 14604-2711, US

(73) Assignee: Multisorb Technologies, Inc., Buffalo, NY (US)

(21) Appl. No.: 12/416,685

(22) Filed: Apr. 1, 2009

(51) Int. Cl. B32B 27/14; B32B 15/01; C09K 3/00

(52) U.S. Cl. 428/35.2; 428/328; 428/407; 252/188.28

(57) ABSTRACT

A well dispersed oxygen scavenging particulate compounded in a polymer matrix. The oxygen scavenging formulation consists of iron powder with a mean particle sizes within 1-25 um and pre-coated with at least one or more activating and acidifying powdered compounds, usually in the form of solid organic and inorganic salts of alkaline and alkaline earth metals such as sodium chloride and sodium bisulfate. The pre-coated iron particulate is dispersed into a polymer resin by using a conventional melt processing method such as twin-screw extrusion. The oxygen scavenging compound is mixed with polymer pellets in the solid state prior to melting. The polymer resin pellets and the coated iron powder are preferably treated with a surfactant in the dry state to help dispersing the iron/salt powder with the resin pellets. The melt extruded compounds are pelletized and kept in the dry state to prevent premature activation.

### BACKGROUND OF THE INVENTION

1. Technical Field

This invention relates to surfactants useful for treating the resin pellets or coated iron powders in order to maximize dispersion that include lubricants such as mineral oil, fatty acids such as stearic acid, and low molecular weight compounds such as waxes.

2. Description of Related Art

U.S. Pat. No. 6,503,587 B2 (to Mitsubishi Gas Chemical Co.) describes a multilayer laminate with the oxygen scavenging particles, including iron, sandwiched between layers. This method could cause interlayer adhesion issues that would inevitably impact the mechanical and consumer properties of the package.

U.S. Pat. No. 6,821,594 B2 (to Mitsubishi Gas Chemical Co.) describes an oxygen absorbing label method with a protruding structure.

U.S. Pat. Nos. 6,559,205 B2 and 7,056,565 B1 (to Chevron Phillips Co.) describes organic-based, branched and pendant cyclic olefinic oxygen scavengers for multilayer containers.

U.S. Pat. No. 7,494,605 (to Cryovac Corp.) describes an oxygen scavenging film with a polymeric oxygen scavenger.

U.S. Pat. No. 6,746,772 B2 (to Mitsubishi Gas Chemical Co.) describes a multilayer film that contains epoxy-curing agents in the film that could result in a stiff and brittle structure.

U.S. Pat. No. 6,063,503 (to Mitsubishi Gas Chemical Co.) describes oxygen absorbing multilayer films that have layer structure and oxygen scavenging particle sizes different from what's described in this invention.

### SUMMARY OF THE INVENTION

In this invention, methods are discovered to make multilayer oxygen scavenging films that fulfill the requirements and differentiating from the prior art. The method is extruding fine oxygen scavenging particles (such as those described in U.S. Pat. No. 6,899,822, US Pat. applications 2005/0205841 and 2007/020456, all to Multisorb Technologies Inc., incorporated in their entirety by reference) in a polymer matrix to form multilayer films. The films can be formed as part of the packaging materials or used as labels or as dividers within the package, or as a part of tray or another rigid support for the product within the package. The films can either be directly extruded with the packaging materials, or integrated with the packages by a post-extrusion processing step such as lamination, gluing or taping. The current invention is particularly focused on iron-based powders with a mean particle size of 1-25 um, where iron particles are pre-coated with activating and oxidation reaction promoter particles to form a homogeneous powder. The films or sheets produced with the finely dispersed such oxygen scavenging particles advantageously possess high clarity and high reactivity with oxygen, compared to larger particles (poor clarity and reactivity) and smaller nanoscale particles (poor clarity).

The first object of this invention is to provide a well dispersed oxygen scavenging particulate compounded in a polymer matrix. The oxygen scavenging formulation consists of iron powder with a mean particle sizes within 1-25 um and pre-coated with at least one or more activating and acidifying powdered compounds, usually in the form of solid organic and inorganic salts of alkaline and alkaline earth metals such as sodium chloride and sodium bisulfate. The pre-coated iron particulate is dispersed into a polymer resin by using a conventional melt processing method such as twin-screw extrusion. The oxygen scavenging compound is mixed with polymer pellets in the solid state prior to melting. The polymer resin pellets and the coated iron powder are preferably treated with a surfactant in the dry state to help dispersing the iron/salt powder with the resin pellets. The melt extruded compounds are pelletized and kept in the dry state to prevent premature activation.

The second object of this invention is to provide a multilayer extruded film or sheet with the iron-containing compound extruded with a polymer. The film or sheet consists of three layers of the same base resin with the layer thickness ratios varying from 5/90/5 to 25/50/25, and with the middle (active) layer comprising the iron based oxygen scavenger dispersed in a resin. The multilayer film can be unoriented (unstretched), uniaxially or biaxially stretched during or after the processing. The active layer thickness, location with the multilayer structure, and the fraction of oxygen scavenger particulate in it are fine tuned to provide the desired functionality (such as the rate of oxygen absorption, the duration of active barrier protection and transient barrier improvement, or their combination).

The third object of this invention is to provide a product-shaped article from the extruded film or sheet through die cutting, pouch making, bag making, lamination, thermoforming or other converting processes. The article may be in the form of adhered or inserted label or as part of the pouch film to fit the product requirements. In particular, the oxygen scavenging films are laminated, taped, bonded onto one of the inner surfaces of a pouch, or simply stored as an insert in a pouch. Optionally the extruded film or sheet is graphically decorated such that it is compatible with the graphic design of the pouch.

The fourth object of this invention is to provide a printed or coated object that contains well dispersed oxygen scavengers compounded in a polymer matrix. The object may be a polymer or metallic substrate with the oxygen scavenging compounds printed or coated onto it. In particular, the iron based oxygen scavenger in the polymer matrix can be extrusion coated or solution printed on a polymer film prior to forming a pouch, bag, or a flexible enclosure for food packages, and in particular, the printed or coated pattern is a part of the graphic design of the package.

### BRIEF DESCRIPTION OF THE DRAWING FIGURES

FIG. 1—Oxygen absorption property of FreshBlend nylon films

### DETAILED DESCRIPTION OF THE INVENTION

This invention relates to methods of extruding oxygen scavenging polymer films that contain finely dispersed oxygen scavenging particulates. The oxygen scavenging film possesses high clarity and tunable oxygen absorption rate. This invention also relates to methods of using such oxygen scavenging films in construction of plastic pouches, bags, flexible enclosures and containers to preserve the freshness of foods and other consumer goods enclosed in the package through absorption of headspace oxygen and/or proving an active barrier to oxygen permeation.

Flexible food packaging materials such as used in a plastic pouch usually require good oxygen barrier properties in order to prevent microbial growth and preserve the freshness of the food. This need can be exemplified by packages such as that for beef jerky, sausages, processed meats, etc. A sachet pack containing oxygen scavenger is commonly used in food pouches to absorb the head space oxygen and to absorb oxygen ingressed through the package wall. Sachets have been used for years in ready-to-serve food packages. However, there are potential disadvantages and limitations associated with the use of sachet. This includes the following:
(a) Sachets are sometimes mistakenly viewed as a part of the food contents and eaten by the consumers.
(b) Sachets are sometimes accidentally cut open causing their contents to spill and contaminate the product when enclosed or fastened to food pouches or packages.
(c) Sachets are sometimes viewed as a nuisance as they disturb the aesthetics and appearance of food packages.
(d) Sachets can not be used for packaging liquid products that require oxygen scavenging.

In accordance with this invention it was discovered that optical properties of polymeric film or sheet substrates such as contact clarity and visible light transmission are advantageously improved if oxygen scavenging particles incorporated into a resin are within 1-25 um in size, and most preferably within 2-5 um in size. Such particles are small enough to be invisible to the naked human eye and at the same time large enough to minimize light scattering by particles of the size comparable to the visible light wavelengths (0.4-0.8 um). The result is a reduced haze of a plastic article into which such particles are incorporated.

Additionally, it was found that a smaller size of composite oxygen scavenging particles (limited by the small particle sizes producing significant light scattering and haze in films), comprising all necessary components for efficient oxidation, produces oxygen scavenging films with higher effective reactivity with permeating oxygen and allows for a more efficient design of barrier structures. Barrier film reactivity is further advantageously improved by multilayer structural designs where the oxygen scavenging layer forms the middle layer of 3-layer structure made from the same matrix resin. The specific optimal layer thickness ratios depend on the overall film thickness and the oxidation kinetics of activated scavenger.

The surfactants useful for treating the resin pellets or coated iron powders in order to maximize dispersion include lubricants such as mineral oil, fatty acids such as stearic acid, and low molecular weight compounds such as waxes.

The reduced iron powder preferably has 1-25 um mean particle size, more preferably 1-10 um mean and most preferably 2-5 um mean. The combination and relative fraction of activating and acidifying components coated onto the iron particles are selected according to the teachings of U.S. Pat. No. 6,899,822, US Pat. applications 2005/0205841 and 2007/020456, incorporated herein by reference. The coating technique is preferably a dry coating as described in the references above.

The film structure is preferably 3 layer or more with the layer ratio in the range of 25/50/25 and 1/98/1, with an optimum ratio depending on the design target (such as the rate of headspace oxygen absorption) with an example ratio being 15/70/15. The coated iron is preferably located in the middle of the three layers.

Films to be used as labels, laminates or inserts for a pouch may consist of single or multilayer structure with the coated iron uniformly distributed in the film or in the chosen layer(s). For a multilayer structure, the coated iron is preferably located in the middle of the structure. It can be located adjacent to the external layer to facilitate absorption.

For the printing or coating the coated iron formulation onto a substrate, the coated iron may be formulated in common extrusion coating polymers such as LDPE, EVA, EAA, PP, PS, waxes, emulsions, etc.

The following examples are used to illustrate some parts of the invention:

### EXAMPLE 1

### Extruded Nylon Films Containing FreshBlend Oxygen Scavenger

An oxygen scavenger package, was prepared by coating iron particulates, 4-5 um mean particle size, with sodium bisulfate and sodium chloride to form a homogeneous coated composite powder. This composite powder, abbreviated as “FreshBlend” oxygen scavenger, was used for extruding with a nylon 6 resin (Custom Resins Nylene 3411). A Coperion twin screw extruder compounding equipment was used for compounding FreshBlend with the resin. A metering feeder was used for precise feeding FreshBlend powder with the polymer resin prior to melting. The resin pellets were mixed with 0.2 wt % mineral oil (retail pharmacy grade) prior to feeding to the extruder. The extruder was set at 250 C for all the heating zones and a die temperature at 260 C. The FreshBlend was fed at a rate comparable to the extrusion rate to result in weight ratio in the range of 5/95 to 20/80. The extruded strands were air cooled, or optionally water cooled prior to pelletizing.

### EXAMPLE 2

### Extrusion of Oxygen Scavenging Films

Oxygen scavenging films were made by using the FreshBlend compounds as prepared in Example 1. Three layer films were extruded from a coextrusion blown film line that consists of three extruders, a coextrusion feedblock, and a 2″ annular die and 0.060″ die gap. Films were made with a blow up ratio=2, and various draw down ratios to result in films in the range of 1.5 to 4 mil thick. The films are clear and transparent with little or no visible agglomeration. The films had a layer ratio of approximately 15/70/15 for materials of nylon/FreshBlend nylon blend/nylon for the respective layers. The net oxygen scavenger content was in the range of 1 to 3 wt % through let-down of the oxygen scavenging compounds.

### EXAMPLE 3

### Oxygen Scavenging Film Performance in Pouch

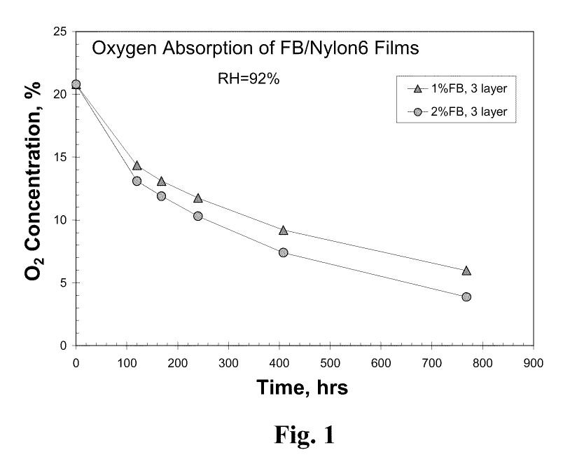

To evaluate the oxygen absorption performance of FreshBlend nylon films working as a label film or insert film in a pouch, the extruded films were cut into stripes and stored in plastic pouches for oxygen absorption property test. The extruded sample films with a chosen weight was cut and stored in a pouch of 6″×6″ dimension. A humidifying agent that delivers 92% relative humidity was also stored in the pouch to activate the oxygen absorption capability by the oxygen scavenger. The pouch was then sealed and subsequently injected 300 cc gas mixture of O2/N2=20/80 into the pouch. The oxygen concentration was measured periodically by using a Mocon model 450 head space analyzer. The oxygen absorption property is shown in FIG. 1. It can be seen that the oxygen concentration decreased gradually with time and with the 2 wt % film decreased at a higher rate than the 1 wt % film. This example demonstrated the utility of the oxygen scavenging film in an enclosure such as a pouch.

Although the invention has been illustrated and described herein with reference to specific embodiments, the invention is not intended to be limited to the details shown. Rather, various modifications may be made in the details within the scope and range of equivalents of the claims and without departing from the invention. Accordingly, it is intended that the appended claims cover all such variations as fall within the spirit and scope of the invention.

1. A method to produce a finely dispersed iron/salt particles in a polymer matrix comprising pre-coating 1-25 um mean particle size iron with at least one or more activating and acidifying powdered components, and mixing this oxygen scavenger with a polymer in the solid state prior to melt extrusion into a compound; treating the pellets or iron/salt powder with a surfactant prior to mixing.

2. An oxygen scavenging film that consists of three or more layers with the oxygen scavenging particulates made in accordance with claim 1 located between other layers. The oxygen scavenging film possesses high clarity with no visible agglomerates.

3. A pouch, bag, flexible enclosure or container that consists of the oxygen scavenging films as label in accordance with claim 1, inserts, laminates or as a part of the multilayer structure, wherein the oxygen scavenging films deliver the oxygen absorbing performance in the enclosure.

4. A pouch, bag, or a flexible enclosure that consists of oxygen scavenger in accordance with claim 1 in the package as a part of the packaging or graphic design.

5. Finely dispersed iron/salt particles in a polymer matrix comprising 1-25 um mean particle size iron pre-coated with at least one or more activating and acidifying powdered components and treated with a surfactant prior to mixing with a polymer in the solid state prior to melt extrusion into a compound.

6. A high clarity with minimal visible agglomerates comprising three or more plastic layers with the oxygen scavenging particulates of claim 5 located between other layers.

7. A pouch, bag, flexible enclosure or container comprising an oxygen scavenging film in accordance with claim 5, in the form of inserts, laminates or as a part of the multilayer structure, wherein the oxygen scavenging films deliver the oxygen absorbing performance in the enclosure.

8. A pouch, bag, or a flexible enclosure that consists of an oxygen scavenger in accordance with claim 5 in the package as a part of the packaging or graphic design.
